(19) United States
(12) Patent Application Publication
(10) Pub. No.: US 2026/0292485 A1
(43) Pub. Date: Sep. 24, 2026

(54) COMMUNICATION METHOD, APPARATUS, DEVICE AND STORAGE MEDIUM

(71) Applicant: BEIJING XIAOMI MOBILE SOFTWARE CO., LTD., Beijing (CN)

(72) Inventor: Wei LU, Beijing (CN)

(73) Assignee: BEIJING XIAOMI MOBILE SOFTWARE CO., LTD., Beijing (CN)

(21) Appl. No.: 19/472,872

(22) PCT Filed: Apr. 7, 2023
(86) PCT No.: PCT/CN2023/087089

§ 371 Date: Oct. 6, 2025

(51) Int. Cl. H04W 12/033; H04W 12/106; H04W 76/10; H04W 84/06

(52) U.S. Cl. CPC H04W 12/033; H04W 12/106; H04W 76/10; H04W 84/06

(57) ABSTRACT

A communication method includes: receiving first information, which is used for instructing to perform a configuration for a terminal to establish a PDU session used for obtaining satellite coverage information; determining a UP security protection policy based on the first information, wherein the UP security protection policy is used for instructing the PDU session to use UP integrity protection; and sending second information, wherein the second information is used for indicating the UP security protection policy.

### CROSS-REFERENCE TO RELATED APPLICATIONS

The present disclosure is a U.S. national phase of PCT Application No. PCT/CN 2023/087089 filed on Apr. 7, 2023, the content of which is hereby incorporated by reference in its entirety.

### TECHNICAL FIELD

The present disclosure relates to the field of communication technologies, and in particular, to communication methods, apparatuses, devices, and storage mediums.

### BACKGROUND

In a current satellite access scenario with discontinuous satellite coverage, satellite coverage information may be provided by an external server to a terminal via a packet data unit (PDU) session of a user plane (UP). The provided satellite coverage information may be used by the terminal in case of discontinuous satellite coverage to determine during which time periods the terminal may be out of a coverage range.

### SUMMARY

According to a first aspect of the embodiments of the present disclosure, a communication method is provided. The method is performed by a first network element and includes: receiving first information, where the first information is for instructing to perform a configuration for a terminal to establish a packet data unit (PDU) session for obtaining satellite coverage information; determining a user plane (UP) security protection policy based on the first information, where the UP security protection policy is for instructing the PDU session to use UP integrity protection; and sending second information, where the second information indicates the UP security protection policy.

According to a second aspect of the embodiments of the present disclosure, a communication method is provided. The method is performed by a second network element and includes: sending first information, where the first information is for instructing to perform a configuration for a terminal to establish a packet data unit (PDU) session for obtaining satellite coverage information; and receiving second information, where the second information indicates a UP security protection policy, and the UP security protection policy is for instructing the PDU session to use UP integrity protection.

According to a third aspect of the embodiments of the present disclosure, a communication method is provided. The method is performed by performed by a core network device, where the core network device includes a first network element and a second network element, and the method includes: sending, by the second network element, first information to the first network element, where the first information is for instructing to perform a configuration for a terminal to establish a packet data unit (PDU) session for obtaining satellite coverage information, and the PDU session is a PDU session between the terminal and an access network device; determining, by the first network element, a user plane (UP) security protection policy based on the first information, where the UP security protection policy is for instructing the PDU session to use UP integrity protection; and sending, by the first network element, second information to the second network element, where the second information indicates the UP security protection policy.

According to a fourth aspect of the embodiments of the present disclosure, a communication device is provided. The communication device includes one or more processors and a memory configured to store instructions executable by the one or more processors; where the one or more processors are configured to perform the method in the first aspect.

According to a fifth aspect of the embodiments of the present disclosure, a communication device is provided. The communication device includes one or more processors and a memory configured to store instructions executable by the one or more processors; where the one or more processors are configured to perform the method in the second aspect.

According to a sixth aspect of the embodiments of the present disclosure, a communication device is provided. The communication device includes one or more processors and a memory configured to store instructions executable by the one or more processors; where the one or more processors are configured to perform the method in the third aspect.

According to a seventh aspect of the embodiments of the present disclosure, a non-transitory computer-readable storage medium is provided. Instructions in the storage medium, when executed by one or more processors of a first network element, enable the first network element to perform the method in the first aspect.

According to an eighth aspect of the embodiments of the present disclosure, a non-transitory computer-readable storage medium is provided. Instructions in the storage medium, when executed by one or more processors of a second network element, enable the second network element to perform the method in the second aspect.

According to a ninth aspect of the embodiments of the present disclosure, a non-transitory computer-readable storage medium is provided. Instructions in the storage medium, when executed by one or more processors of a terminal, enable the terminal to perform the method in the third aspect.

It should be understood that the above general description and the detailed description in the following text are only exemplary and explanatory, and cannot limit the present disclosure.

### BRIEF DESCRIPTION OF DRAWINGS

The accompanying drawings herein are incorporated into the specification and form a part of this specification, show embodiments conforming to the present disclosure and are used together with the specification to explain principles of the present disclosure.

FIG. 1 is a schematic diagram of a wireless communication system shown according to an exemplary embodiment.

FIG. 2 is a flowchart of a communication method shown according to an exemplary embodiment.

FIG. 3 is a flowchart of another communication method shown according to an exemplary embodiment.

FIG. 4 is a flowchart of still another communication method shown according to an exemplary embodiment.

FIG. 5 is a flowchart of yet another communication method shown according to an exemplary embodiment.

FIG. 6 is a flowchart of another communication method shown according to an exemplary embodiment.

FIG. 7 is a flowchart of still another communication method shown according to an exemplary embodiment.

FIG. 8 is a flowchart of yet another communication method shown according to an exemplary embodiment.

FIG. 9 is a flowchart of another communication method shown according to an exemplary embodiment.

FIG. 10 is a flowchart of still another communication method shown according to an exemplary embodiment.

FIG. 11 is a flowchart of yet another communication method shown according to an exemplary embodiment.

FIG. 12 is a flowchart of another communication method shown according to an exemplary embodiment.

FIG. 13 is a schematic diagram of an interaction of a communication method shown according to an exemplary embodiment.

FIG. 14 is a schematic diagram of an interaction of another communication method shown according to an exemplary embodiment.

FIG. 15 is a schematic diagram of a communication apparatus shown according to an exemplary embodiment.

FIG. 16 is a schematic diagram of another communication apparatus shown according to an exemplary embodiment.

FIG. 17 is a schematic diagram of still another communication apparatus shown according to an exemplary embodiment.

FIG. 18 is a schematic diagram of yet another communication apparatus shown according to an exemplary embodiment.

FIG. 19 is a schematic diagram of a communication apparatus shown according to an exemplary embodiment.

FIG. 20 is a schematic diagram of another communication apparatus shown according to an exemplary embodiment.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with the present disclosure.

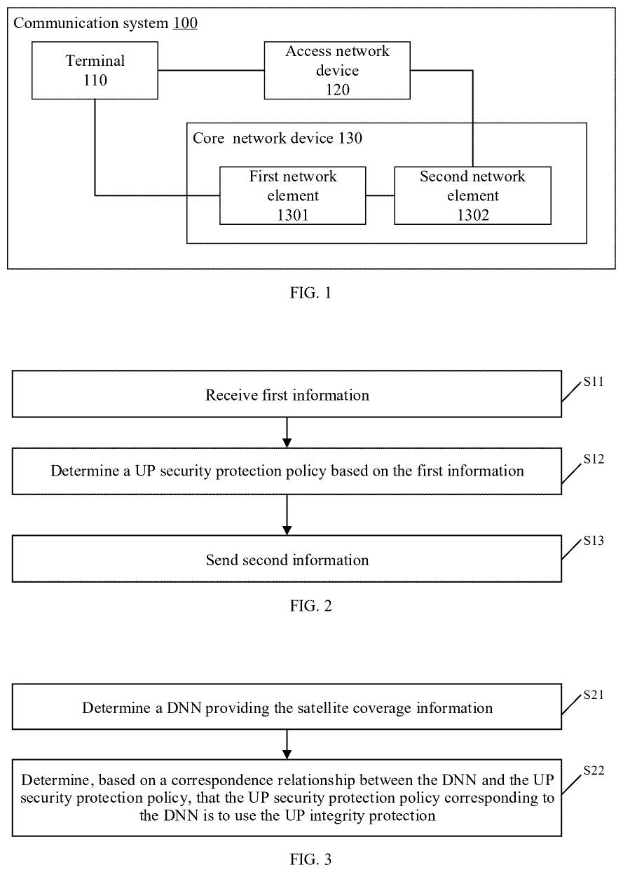

The communication method involved in the present disclosure may be applied to the wireless communication system 100 shown in FIG. 1. The network system may include a terminal 110, an access network device 120, and a core network device 130. It should be understood that the wireless communication system 100 shown in FIG. 1 is only for schematic explanation. The wireless communication system 100 may also include other network devices, such as wireless relay devices, wireless backhaul devices, etc., which are not shown in FIG. 1. The embodiments of the present disclosure do not limit the number of the access network devices, and the number of the core network devices, and the number of the terminals included in the wireless communication system 100.

It can be further understood that the wireless communication system 100 of the present embodiment is a network that provides a wireless communication function. The wireless communication system 100 may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), carrier sense multiple access with collision avoidance. According to factors of different networks, such as a capacity, a speed, and a latency, the networks may be categorized into a 2G (generation) network, a 3G network, a 4G network, or a future evolution network, such as a 5th generation wireless communication system (5G) network that is also referred to as a new radio (NR). For the convenience of description, the wireless communication network 100 is sometimes referred to as a network in the present disclosure.

Moreover, the terminal 110 involved in the present disclosure is also referred to as a terminal device, user equipment (UE), a mobile station (MS), a mobile terminal (MT), etc., and is a device that provides voice and/or data connectivity to a user. For example, the terminal 110 may be a handheld device, a vehicle-mounted device, etc., that has a wireless connection function. At present, examples of some terminals are smartphones (mobile phone), pocket personal computers (PPC), handheld computers, personal digital assistants (PDA), laptops, tablets, wearable devices, or vehicle-mounted devices, etc. Additionally, when the network is the Vehicle-to-Everything (V2X) communication system, the terminal devices may also be vehicle-mounted devices. It should be understood that specific technologies and specific device forms adopted by the terminals are not limited in the embodiments of the present disclosure.

Moreover, the access network device 120 involved in the present disclosure may also be referred to as a wireless access network device. The wireless access network devices may be: base stations, evolved node Bs (eNBs), home base stations, access points (AP) in a wireless fidelity (WIFI) system, wireless relay nodes, wireless backhaul nodes, transmission points (TP), or transmission and receiving points (TRP), etc. The wireless access network devices may also be: gNBs in a NR system, or components or part of the devices constituting the base stations, etc. When the network is a Vehicle-to-Everything (V2X) communication system, the network devices may also be vehicle-mounted devices. It should be understood that specific technologies and specific device forms used by the network device are not limited in the embodiments of the present disclosure.

Further, the core network device 130 in the present disclosure may be a device including a first network element 1301 and a second network element 1302. Certainly, the core network device 130 may further include any other network element than the first network element 1301 and the second network element 1302. Alternatively, the core network devices 130 may be a plurality of devices or a plurality of device groups, each including all or a part of the first network element 1301, the second network element 1302, and any other network element. The network element may be virtual or entity. The core network includes, for example, at least one of an evolved packet core (EPC), a 5G core network (5GCN), or a next generation core (NGC).

In some embodiments, the first network element 1301 is an authentication management function (AMF) network element, for example.

In some embodiments, the second network element 1302 is a session management function (SMF) network element, for example.

In the embodiments of the present disclosure, the terminal 110, the access network device 120, and the core network device 130 may use any feasible wireless communication technology to implement mutual data transmission. A transmission channel corresponding to sending, by the terminal 110, data or control information to the access network device 120 is referred to as an uplink (UL) channel, and a transmission channel corresponding to sending, by the access network device 120, the data or control information to the terminal 110 is referred to as a downlink (DL) channel. It may be understood that the access network device involved in the embodiments of the present disclosure may be a base station. Certainly, the access network device may alternatively be any other possible access network device, and the terminal may be any possible terminal, which is not limited in the present disclosure.

In a current satellite access scenario with discontinuous satellite coverage, for example, in a 3rd generation partnership project (3GPP) release (R) 18 standard, it points out that satellite coverage information may be provided by an external server to a terminal via a PDU session of a user plane. The provided satellite coverage information may be used by the terminal in case of discontinuous satellite coverage to determine during which time periods the terminal may be out of a coverage range.

If the satellite coverage information sent from the external server to the terminal is not properly protected, the terminal may receive false coverage information tampered by an attacker. In this case, the terminal cannot accurately determine the time period information when the terminal is located outside the coverage range. If the terminal determines that the time period when the terminal is outside the coverage range is wrong, the terminal may be misguided by the wrong information; for example, when the terminal is still within the satellite coverage range, the terminal deactivates an access stratum (AS) function, to cause service termination. Alternatively, the terminal is misguided by the wrong information; for example, the terminal is already out of the satellite coverage range, but the terminal still maintains an active state of the AS function. Therefore, the terminal causes unnecessary power consumption. Obviously, the above situation may be considered as a DOS attack on the terminal.

Therefore, it is necessary to protect the satellite coverage information from being tampered during transmission of the satellite coverage information from the external server to the terminal.

Currently, whether the transmission of the satellite coverage information from the external server to the terminal should be protected, and how to protect the satellite coverage information have not yet been discussed.

In some solutions, the terminal and the external server may have a credential preconfigured for establishing the security of an application layer. The satellite coverage information may then be protected in the application layer between the terminal and the external server. However, since the terminal may move from one place to another place, and the satellite coverage information sent to the terminal may be associated with a region. Therefore, the terminal may need to obtain satellite coverage information of different regions from different external servers. For example, a terminal residing in an A-site network will obtain the satellite coverage information from an external server deployed by an A-site satellite provider. However, when the terminal moves to a B-site network, the terminal will obtain the satellite coverage information from an external server deployed by a B-site satellite provider. However, it is not practical to preconfigure the terminal with all credentials for establishing the security of the application layer with external servers deployed by different satellite providers. Thus, it may be considered that the security of the application layer is not always available. When the satellite coverage information is transmitted via the PDU session of the user plane, it may be considered necessary to provide the user plane security for the related PDU session.

Therefore, in the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

FIG. 2 is a flowchart of a communication method shown according to an exemplary embodiment. As shown in FIG. 2, the method is performed by a first network element and may include the following steps S11-S13.

At step S11, first information is received.

In some embodiments, the first network element may receive the first information. The first information may be for instructing to perform a configuration for a terminal to establish a packet data unit (PDU) session for obtaining satellite coverage information. The PDU session may be a PDU session between a terminal and an access network device.

In some embodiments, the first network element may be a session management function (SMF) network element.

For example, the SMF network element receives the first information. The first information may be request information for instructing to perform a configuration for the terminal to establish a PDU session for obtaining the satellite coverage information. That is, a network SMF network element creates a session management (SM) context request for the PDU session, which may be denoted as a Nsmf_PDUSession_CreateSMContext request.

In some embodiments, the first information may be sent by a second network element, that is, the first network element receives the first information sent by the second network element. The second network element may be an AMF network element, for example.

At step S12, a user plane (UP) security protection policy is determined based on the first information.

In some embodiments, the first network element may determine the UP security protection policy based on the received first information.

For example, the UP security protection policy may include a first policy, a second policy, and a third policy. The first policy may be denoted as “required”. The second policy may be denoted as “preferred”. The third policy may be denoted as “not needed”. The first network element may determine, based on the first information, that the UP security protection policy is any one of the above policies.

Certainly, in some embodiments, the first network element determines, based on the first information, that the UP security protection policy is the first policy in the above policies, that is, determines that the UP security protection policy is “required”. It may be understood that the “required” may be used for instructing the PDU session to use the UP integrity protection, or it may be considered that the PDU session must use the UP integrity protection.

It may be understood that the UP security protection policy mentioned in the embodiments of the present disclosure is “required”, which means that the UP security protection policy is “to use the UP integrity protection (or using the UP integrity protection)”, or may mean that the UP security protection policy “should use the UP integrity protection”. “Should use” may be understood as “need to use”, or “it is necessary to use”, or “have to use”.

For another example, if it is determined that the UP security protection policy is “preferred”, the UP security protection policy may be used for instructing the PDU session to preferably use the UP integrity protection. That is, some special conditions may be preset; in a case where the special conditions are met, it may be determined that the PDU session does not use the UP integrity protection; and in a case where the special conditions are not met, it may be the default that the PDU session uses the UP integrity protection. Alternatively, some special conditions may be preset; in a case where the special conditions are met, it may be determined that the PDU session uses the UP integrity protection; and in a case where the special conditions are not met, it may be the default that the PDU session does not use the UP integrity protection.

For another example, if it is determined that the UP security protection policy is “not needed”, the UP security protection policy may be used for instructing the PDU session not to use the UP integrity protection. It may be understood that “not needed” may be used for instructing the PDU session to prohibit to use the UP integrity protection, or it may be considered that the PDU session must not use the UP integrity protection.

It may be understood that, in the embodiments of the present disclosure, in order to ensure that the security of the satellite coverage information during the PDU session between the terminal and the network device may be guaranteed, generally, the UP security protection policy may be set as “required”, so that, in any case, the UP integrity protection may be implemented on data transmitted in the PDU session.

In some embodiments, the first information may include a data network name (DNN). The DNN may provide the satellite coverage information. The first network element may determine, based on the DNN in the first information, that the UP security protection policy is “required”. The DNN may be a DNN providing a data network for the above PDU session.

In some embodiments, the first information may not include the DNN. In this case, the first information may carry indication information used for requesting satellite coverage information. The first network element may determine, based on the indication information carried in the first information, a DNN that may provide the satellite coverage information. The first network element may further determine, based on the determined DNN, that the UP security protection policy is “required”.

In some embodiments, the UP security protection policy may include UP integrity protection, which is referred to as UP integrity security protection, or referred to as a UP integrity protection policy. It may be understood that the UP integrity protection protects the integrity of the data, for example, protects the integrity of the satellite coverage information, to prevent the satellite coverage information from being maliciously tampered. Certainly, in some other embodiments, the UP security protection policy may further include UP confidentiality protection, which is referred to as UP confidentiality security protection, or referred to as a UP confidentiality protection policy. It can be understood that the UP confidentiality protection protects confidential information of the data. For example, data confidentiality transmitted in the PDU session is protected, to prevent confidential or private related information, etc., from being tampered.

At step S13, second information is sent.

In some embodiments, the first network element may send the second information. The second information may be used for indicating the UP security protection policy.

For example, the first network element may send the second information to the second network element. In this way, the second network element determines the UP security protection policy based on the received second information. For example, the second network element determines that the UP security protection policy is “required”.

For example, the SMF network element sends second information to the AMF network element, where the second information may be response information for instructing to perform a configuration for the terminal to establish a PDU session for obtaining the satellite coverage information. For example, the response information is a Nsmf_PDUSession_CreateSMContext response. The Nsmf_PDUSession_CreateSMContext response may carry information used for indicating the UP security protection policy. For example, certain information carried in the Nsmf_PDUSession_CreateSMContext response indicates that the UP security protection policy is set as “required”.

In the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided in this embodiment of the present disclosure, the first information carries the DNN that may provide the satellite coverage information. Determining the UP security protection policy based on the first information in the step S12 may include: determining, based on a preconfigured correspondence relationship between DNNs and UP security protection policies, that the UP security protection policy corresponding to the DNN is to use the UP integrity protection.

In some embodiments, the first information may carry the DNN. The DNN is a DNN that may provide the satellite coverage information. The first network element may determine, based on a correspondence relationship between DNNs and UP security protection policies, that the UP security protection policy corresponding to the DNN is to use the UP integrity protection.

For example, the first information sent by the second network element may carry the DNN. The DNN is a DNN that may provide the satellite coverage information. The first network element is preconfigured with a correspondence relationship between DNNs and UP security protection policies. The first network element may determine, based on the DNN carried in the first information and based on the preconfigured correspondence relationship between DNNs and UP security protection policies, the UP security protection policy corresponding to the DNN carried in the first information. The UP security protection policy corresponding to the DNN carried in the first information is to use the UP integrity protection. For example, the UP security protection policy corresponding to the DNN carried in the first information is “required”.

In some embodiments, the correspondence relationship between DNNs and UP security protection policies may be preconfigured and stored in the second network element. Alternatively, the correspondence relationship between DNNs and UP security protection policies may be prestored in another network element, and the second network element may send a request to the network element storing the correspondence relationship to obtain the correspondence relationship between DNNs and UP security protection policies, or may receive information from the another network element, where the information may indicate the correspondence relationship between DNNs and UP security protection policies. In other words, the second network element may perform the configuration through another device, for example, another network element, and determine the correspondence relationship between DNNs and UP security protection policies by interacting with another network element, which is not limited in the present disclosure.

It may be understood that, in some embodiments, the first network element, for example, the SMF network element, may be locally preconfigured with the correspondence relationship between DNNs and UP security protection policies. In a case where the first information received by the SMF network element carries the DNN, the SMF network element may determine, based on the preconfigured correspondence relationship between DNNs and UP security protection policies, the UP security protection policy corresponding to the DNN carried in the first information. Certainly, in various embodiments of the present disclosure, if the DNN includes the satellite coverage information, the UP security protection policy corresponding to such DNN is “required”.

In the present disclosure, in the case where the first information carries the DNN, by instructing the terminal to perform the PDU session by using the UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided in this embodiment of the present disclosure, the first information carries first indication information, where the first indication information is for indicating to request the satellite coverage information. FIG. 3 is a flowchart of another communication method shown according to an exemplary embodiment. The method is performed by a first network element, and as shown in FIG. 3, determining the UP security protection policy based on the first information in the step S12 may include the following steps S21-S22.

At step S21, a DNN providing the satellite coverage information is determined.

In some embodiments, the first information may not carry the DNN. For example, the first information does not carry the DNN that may provide the satellite coverage information. In this case, the first information may carry first indication information. The first indication information may be used for indicating to request the satellite coverage information. It may be understood that because the first information does not carry the DNN that may provide the satellite coverage information, the first information may carry indication information for requesting the satellite coverage information. In this way, the first network element may determine, based on the first indication information in the first information, a DNN that may provide the satellite coverage information.

For example, the first information received by the first network element does not carry the DNN, and the first information carries the first indication information for requesting the satellite coverage information. The first network element may determine, based on the first indication information, the DNN that may provide the satellite coverage information.

For example, the first information received by the SMF network element and sent by the AMF network element does not carry the DNN, and the first information carries the first indication information for requesting the satellite coverage information. The SMF network element may determine, based on the first indication information, the DNN that may provide the satellite coverage information.

At step S22, it is determined, based on a correspondence relationship between DNNs and UP security protection policies, that the UP security protection policy corresponding to the DNN is to use the UP integrity protection.

In some embodiments, the first network element may be preconfigured with the correspondence relationship between DNNs and UP security protection policies. The first network element may determine, based on the preconfigured correspondence relationship, that the UP security protection policy corresponding to the DNN determined in the step S21 is to use the UP integrity protection.

For example, the first network element is preconfigured with a correspondence relationship between DNNs and UP security protection policies. The first network element may determine, based on the preconfigured correspondence relationship between DNNs and UP security protection policies, the UP security protection policy corresponding to the DNN determined in the step S21. The UP security protection policy is “required”.

For example, the SMF network element is preconfigured with the correspondence relationship between DNNs and UP security protection policies. The SMF network element may determine, based on the preconfigured correspondence relationship between DNNs and UP security protection policies, that the UP security protection policy corresponding to the DNN determined in the step S21 is “required”.

In some embodiments, the correspondence relationship between DNNs and UP security protection policies may be preconfigured and stored in the second network element. Alternatively, the correspondence relationship between DNNs and UP security protection policies may be prestored in another network element, and the second network element may send a request to the network element storing the correspondence relationship to obtain the correspondence relationship between DNNs and UP security protection policies, or may receive information from the another network element, where the information may indicate the correspondence relationship between DNNs and UP security protection policies. In other words, the second network element may perform the configuration through another device, for example, another network element, and determine the correspondence relationship between DNNs and UP security protection policies by interacting with another network element, which is not limited in the present disclosure.

It may be understood that, in some embodiments, the first network element, for example, the SMF network element, may be locally preconfigured with the correspondence relationship between DNNs and UP security protection policies. When the first information received by the SMF network element does not carry the DNN, and the first information carries first indication information used for indicating to request the satellite coverage information, the SMF network element may determine, based on the first indication information, the DNN that may provide the satellite coverage information, and determine, based on the preconfigured correspondence relationship between DNNs and UP security protection policies, the UP security protection policy corresponding to the DNN that may provide the satellite coverage information. Certainly, in various embodiments of the present disclosure, if the DNN may provide the satellite coverage information, the UP security protection policy corresponding to such DNN is “required”.

It may be understood that each step shown in FIG. 3 may be implemented in any combination with or separately and independently from each step shown in FIG. 2, which is not limited in the present disclosure.

In the present disclosure, the first information does not carry the DNN, and the first information carries the first indication information used for indicating to request the satellite coverage information. In this case, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

Based on the same concept, the present disclosure further provides a communication method performed by a second network element.

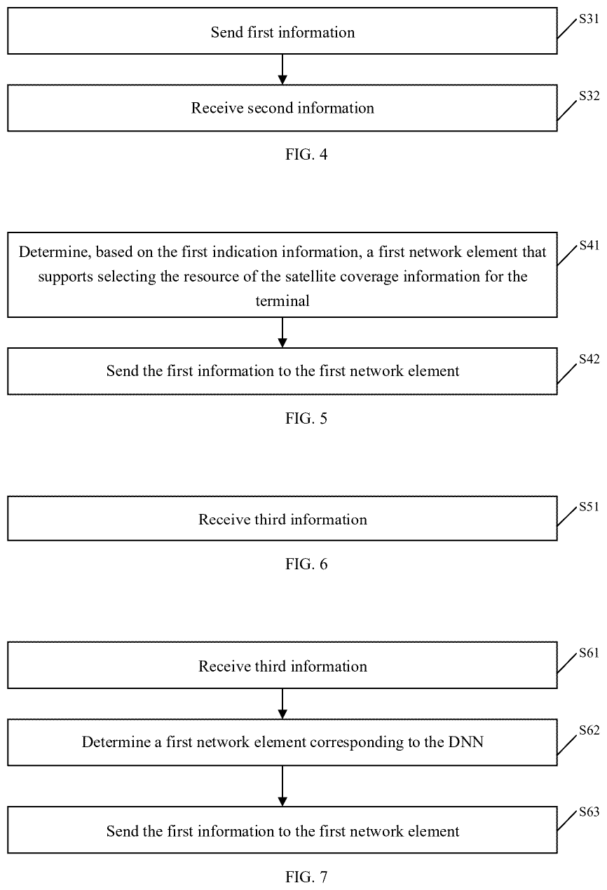

FIG. 4 is a flowchart of still another communication method shown according to an exemplary embodiment. As shown in FIG. 4, the method is performed by a second network element and may include the following steps S31-S32.

At step S31, first information is sent.

In some embodiments, the second network element may send the first information. The first information may be for instructing to perform a configuration for the terminal to establish a PDU session for obtaining the satellite coverage information. The PDU session may be a PDU session between a terminal and an access network device.

In some embodiments, the second network element may be an AMF network element.

For example, the AMF network element sends the first information. The first information may be request information for instructing to perform a configuration for the terminal to establish a PDU session for obtaining the satellite coverage information. For example, the response information is a Nsmf_PDUSession_CreateSMContext request.

In some embodiments, the second network element may send the first information to the first network element. The first network element may be an SMF network element, for example.

In some embodiments, the first information may include the DNN. The DNN include the satellite coverage information. In this case, the DNN in the first information may be used by the first network element to determine, based on the DNN, that the UP security protection policy is “required”. The DNN may be a DNN providing a data network for the above PDU session.

In some embodiments, the first information may not include the DNN. In addition, the first information may carry indication information used for requesting the satellite coverage information. In this case, the first indication information in the first information may be used by the first network element to determine, based on the indication information, the DNN that may provide the satellite coverage information. In addition, the first indication information may be used by the first network element to determine, based on the determined DNN, that the UP security protection policy is “required”.

At step S32, second information is received.

In some embodiments, the second network element may receive the second information. For example, the second information sent by the first network element is received. The second information may be used for indicating the UP security protection policy.

For example, the second network element may receive the second information sent by the first network element. In addition, the second network element may determine the UP security protection policy based on the received second information. For example, the second network element determines that the UP security protection policy is “required”.

For example, the AMF network element receives the second information sent by the SMF network element, where the second information may be a Nsmf_PDUSession_CreateSMContext response. The Nsmf_PDUSession_CreateSMContext response may carry information used for indicating the UP security protection policy. For example, certain information carried in the Nsmf_PDUSession_CreateSMContext response indicates that the UP security protection policy is set as “required”.

In some embodiments, the UP security protection policy may include a first policy, a second policy, and a third policy. The first policy may be denoted as “required”. The second policy may be denoted as “preferred”. The third policy may be denoted as “not needed”. The first network element may determine, based on the first information, that the UP security protection policy is any one of the above policies.

It may be understood that the “required” may be used for instructing the PDU session to use the UP integrity protection, or it may be considered that the PDU session must use the UP integrity protection.

For example, if the UP security protection policy is “preferred”, the UP security protection policy may be used for instructing the PDU session to preferably use the UP integrity protection. That is, some special conditions may be preset; in a case where the special conditions are met, it may be determined that the PDU session does not use the UP integrity protection; and in a case where the special conditions are not met, it may be the default that the PDU session uses the UP integrity protection. Alternatively, some special conditions may be preset; in a case where the special conditions are met, it may be determined that the PDU session uses the UP integrity protection; and in a case where the special conditions are not met, it may be the default that the PDU session does not use the UP integrity protection.

For another example, if it is determined that the UP security protection policy is “not needed”, the UP security protection policy may be used for instructing the PDU session not to use the UP integrity protection. It may be understood that “not needed” may be used for instructing the PDU session to prohibit to use the UP integrity protection, or it may be considered that the PDU session must not use the UP integrity protection.

In some embodiments, the UP security protection policy may include UP integrity protection, which is referred to as UP integrity security protection, or referred to as a UP integrity protection policy. It may be understood that the UP integrity protection protects the integrity of the data, for example, protects the integrity of the satellite coverage information, to prevent the satellite coverage information from being maliciously tampered. Certainly, in some other embodiments, the UP security protection policy may further include UP confidentiality protection, which is referred to as UP confidentiality security protection, or referred to as a UP confidentiality protection policy. It can be understood that the UP confidentiality protection protects confidential information of the data. For example, data confidentiality transmitted in the PDU session is protected, to prevent confidential or private related information, etc., from being tampered.

It may be understood that each step shown in FIG. 4 may be implemented in any combination with or separately and independently from each step shown in FIG. 2 and each step shown in FIG. 3, which is not limited in the present disclosure.

In the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided in this embodiment of the present disclosure, the first information carries first indication information, where the first indication information is for indicating to request the satellite coverage information. FIG. 5 is a flowchart of yet another communication method shown according to an exemplary embodiment. The method is performed by the second network element, and as shown in FIG. 5, the method may further include the following steps S41-S42.

At step S41, it is determined, based on the first indication information, a first network element that supports selecting the resource of the satellite coverage information for the terminal.

In some embodiments, the first information may not carry the DNN. For example, the first information does not carry the DNN that may provide the satellite coverage information. In this case, the first information may carry first indication information. The first indication information may be used for indicating to request the satellite coverage information. It may be understood that because the first information does not carry the DNN that may provide the satellite coverage information, the first information may carry indication information used for requesting the satellite coverage information. The second network element may determine, based on the first indication information, a first network element that supports selecting the resource of the satellite coverage information for the terminal. In this way, the first network element may determine, based on the first indication information in the first information, a DNN that may provide the satellite coverage information.

For example, the first information sent by the second network element does not carry the DNN, and the first information carries the first indication information for requesting the satellite coverage information. In this way, the first network element may determine, based on the first indication information included in the received first information, a DNN that may provide the satellite coverage information.

For example, the AMF network element sends the first information to the SMF network element. The first information does not carry the DNN, and carries the first indication information for requesting the satellite coverage information. The SMF network element receives the first information. In this way, the SMF network element may determine, based on the first indication information in the first information, the DNN that may provide the satellite coverage information.

Sending the first information in the step S31, may further include the following step S42.

At step S42, the first information is sent to the first network element.

In some embodiments, the second network element may send the first information to the first network element determined in the step S41. The first information carries first indication information.

For example, the second network element sends the first information carrying the first indication information to the first network element determined in the step S41. In this way, the first network element may determine, based on the first information carrying the first indication information, that the UP security protection policy is to use the UP integrity protection.

For example, the AMF network element sends the first information carrying the first indication information to the SMF network element determined in the step S41. It may be understood that the SMF network element determined in the step S41 is an SMF network element that supports selecting a resource of the satellite coverage information for the terminal. In other words, one or more DNNs may be preconfigured in the SMF network element. There is the DNN including the satellite coverage information in the one or more DNNs. It may be understood that, in this example, the AMF network element sends the first information carrying the first indication information to the SMF network element. For the SMF network element, the DNN that may provide the satellite coverage information may be determined based on the first indication information in the received first information. In addition, it is determined, based on the DNN, that the UP security protection policy is to use the UP integrity protection, that is, the UP security protection policy is “required”.

Certainly, a specific manner in which the SMF network element determines that the UP security protection policy is “required” may refer to the corresponding description in the step S22, which will not be repeated in the present disclosure.

It may be understood that each step shown in FIG. 5 may be implemented in any combination with or separately and independently from each step shown in FIG. 2, each step shown in FIG. 3, and each step shown in FIG. 4, which is not limited in the present disclosure.

In the present disclosure, the first information does not carry the DNN, and the first information carries the first indication information used for indicating to request the satellite coverage information. In this case, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided by the embodiment of the present disclosure, FIG. 6 is a flowchart of another communication method shown according to an exemplary embodiment. The method is performed by the second network element, and as shown in FIG. 6, the method may further include the following step S51.

At step S51, third information is received.

In some embodiments, the second network element may receive the third information. The third information may be used for indicating to request establishment of a PDU session between the terminal and the access network device. The third information carries the first indication information.

For example, the second network element may receive the third information sent by the terminal. It may be understood that the third information may be sent by the terminal to the access network device and forwarded by the access network device to the second network element. The third information may be a PDU session establishment request. For example, the third information may be denoted as a “PDU session establishment request”. It may be understood that the “PDU session establishment request” carries the first indication information. The first indication information may represent indication information for requesting the satellite coverage information (indication for coverage information).

It may be understood that, in the case of receiving the “PDU session establishment request” that carries “indication for coverage information”, the second network element, such as the AMF network element, may determine, based on the “indication for coverage information”, the first network element that supports selecting the resource of the satellite coverage information for the terminal, that is, determine the SMF network element that supports selecting the resource of the satellite coverage information for the terminal. The AMF network element sends the “Nsmf_PDUSession_CreateSMContext request” carrying the “indication for coverage information” to the SMF network element. In this way, the SMF network element determines, based on the “indication for coverage information” in the “Nsmf_PDUSession_CreateSMContext request”, a DNN that may provide the satellite coverage information. In addition, it is determined, based on the DNN, that the UP security protection policy is to use the UP integrity protection, that is, the UP security protection policy is “required”.

It may be understood that each step shown in FIG. 6 may be implemented in any combination with or separately and independently from each step shown in FIG. 2, each step shown in FIG. 3, each step shown in FIG. 4, and each step shown in FIG. 5, which is not limited in the present disclosure.

In the present disclosure, the second network element receives the third information carrying the first indication information, to send the first information carrying the first indication information to the first network element. In this way, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided by the embodiment of the present disclosure, FIG. 7 is a flowchart of still another communication method shown according to an exemplary embodiment. The method is performed by the second network element, and as shown in FIG. 7, the method may further include the following steps S61-S63.

At step S61, third information is received.

In some embodiments, the second network element may receive the third information. The third information may carry the DNN. That is, the third information carries the DNN including the satellite coverage information.

For example, the second network element may receive the third information sent by the terminal. For example, the third information may be a “PDU session establishment request”. It may be understood that the “PDU session establishment request” carries a DNN, that is, the “PDU session establishment request” carries a DNN including the satellite coverage information.

At step S62, a first network element corresponding to the DNN is determined.

In some embodiments, the second network element may determine the first network element corresponding to the DNN.

For example, the AMF network element determines the SMF network element corresponding to the DNN carried in the third information. It may be understood that, in the case of receiving the “PDU session establishment request” carrying the DNN, the second network element, such as the AMF network element, may determine, based on the DNN, the first network element corresponding to the DNN, that is, determine the SMF network element corresponding to the DNN.

Sending the first information in the step S31, may further include the following step S63.

At step S63, the first information is sent to the first network element.

In some embodiments, the second network element may send the first information to the first network element determined in the step S62. The first information carries the DNN.

For example, the AMF network element sends the “Nsmf_PDUSession_CreateSMContext request” carrying the DNN to the SMF network element. In this way, the SMF network element determines, based on the DNN in the “Nsmf_PDUSession_CreateSMContext request”, that the UP security protection policy is to use the UP integrity protection, that is, the UP security protection policy is “required”.

It may be understood that each step shown in FIG. 7 may be implemented in any combination with or separately and independently from each step shown in FIG. 2, each step shown in FIG. 3, each step shown in FIG. 4, each step shown in FIG. 5, and each step shown in FIG. 6, which is not limited in the present disclosure.

In the present disclosure, the second network element receives the third information carrying the DNN, to send the first information carrying the DNN to the first network element. In this way, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

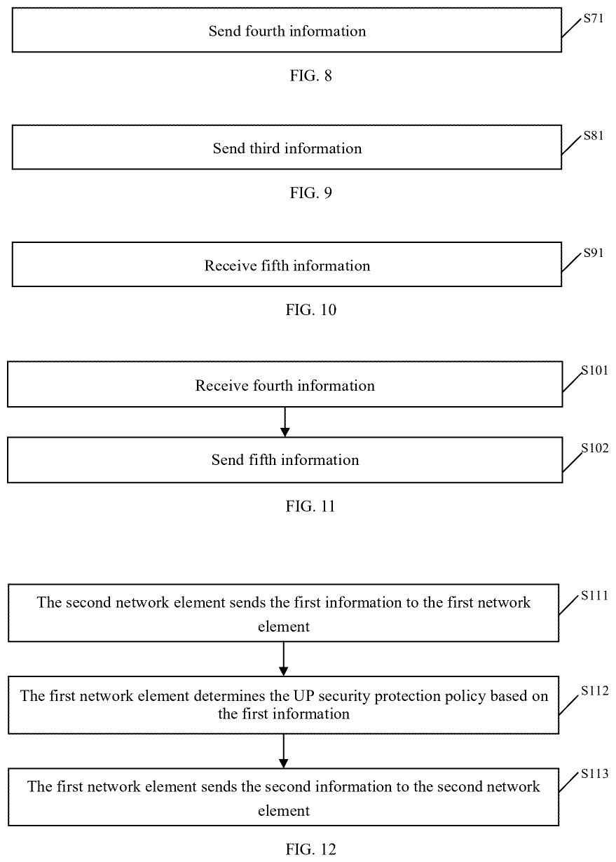

In the communication method provided by the embodiment of the present disclosure, FIG. 8 is a flowchart of yet another communication method shown according to an exemplary embodiment. The method is performed by the second network element, and as shown in FIG. 8, the method may further include the following step S71.

At step S71, fourth information is sent.

In some embodiments, the second network element may send the fourth information to the access network device. The fourth information may instruct the access network device to use the UP integrity protection.

For example, the access network device may be a non-terrestrial network (NTN)-radio access network (RAN). The second network element is an AMF network element. The AMF network element may send the fourth information to the NTN-RAN, where the fourth information carries information indicating that the UP security protection policy is to use the UP integrity protection. The fourth information may be an “N2 PDU session request”. The “N2 PDU session request” carries information indicating that the UP security protection policy is “required”.

It may be understood that when the access network device receives the “N2 PDU session request” carrying information indicating that the UP security protection policy is “required”, the access network device may determine that the UP security protection policy of the PDU session established between the access network device and the terminal is “required”. Therefore, the integrity and security of the satellite coverage information transmitted between the terminal and the access network device is protected.

It may be understood that each step shown in FIG. 8 may be implemented in any combination with or separately and independently from each step shown in FIG. 2, each step shown in FIG. 3, each step shown in FIG. 4, each step shown in FIG. 5, each step shown in FIG. 6, and each step shown in FIG. 7, which is not limited in the present disclosure.

In the present disclosure, the second network element indicates the UP security protection policy to the access network device, so that by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

Based on the same concept, the present disclosure further provides a communication method performed by a terminal.

FIG. 9 is a flowchart of another communication method shown according to an exemplary embodiment. As shown in FIG. 9, the method is performed by a terminal and may include the following step S81.

At step S81, third information is sent.

In some embodiments, the terminal may send the third information. The third information is used for indicating to request to establish a PDU session for obtaining the satellite coverage information between the terminal and the access network device.

For example, the terminal sends the third information. It may be understood that the terminal sends the third information to the access network device, and forwards the third information to the second network element via the access network device. For example, the terminal sends the third information to the access network device, and forwards the third information to the AMF network element via the access network device. For example, the third information may be a “PDU session establishment request”. The terminal sends the “PDU session establishment request” to the AMF network element to establish a PDU session between the terminal and the access network device.

In some embodiments, the third information includes first indication information, and the first indication information is for indicating to request the satellite coverage information.

For example, the third information sent by the terminal may include first indication information used for indicating to request the satellite coverage information. For example, the third information sent by the terminal to the access network device and forwarded to the AMF network element via the access network device may include the first indication information. Because the third information includes the first indication information, the AMF network element may determine, based on the first indication information, the first network element that supports selecting the resource of the satellite coverage information for the terminal. For example, the AMF network element determines the SMF network element that supports selecting the resource of the satellite coverage information for the terminal. In this way, the AMF network element sends the first information carrying the first indication information to the SMF network element, and the SMF network element determines, based on the first indication information in the first information, a DNN that may provide the satellite coverage information. In addition, it is determined, based on the DNN, that the UP security protection policy is to use the UP integrity protection, that is, the UP security protection policy is “required”. It may be understood that the UP security protection policy is “required”, that is, configuration of the UP security protection policy for the PDU session is “required”.

In some embodiments, the third information includes the DNN. The DNN is a DNN including the satellite coverage information.

For example, the third information sent by the terminal may include the DNN. For example, the third information may be a “PDU session establishment request”. It may be understood that the “PDU session establishment request” carries a DNN, that is, the “PDU session establishment request” carries a DNN including the satellite coverage information. In this way, in the case of receiving the “PDU session establishment request” carrying the DNN, the AMF network element may determine, based on the DNN, the first network element corresponding to the DNN, that is, determine the SMF network element corresponding to the DNN. In addition, the AMF network element sends the “Nsmf_PDUSession_CreateSMContext request” carrying the DNN to the SMF network element. In this way, the SMF network element determines, based on the DNN in the “Nsmf_PDUSession_CreateSMContext request”, that the UP security protection policy is to use the UP integrity protection, that is, the UP security protection policy is “required”.

In some embodiments, the UP security protection policy may include a first policy, a second policy, and a third policy. The first policy may be denoted as “required”. The second policy may be denoted as “preferred”. The third policy may be denoted as “not needed”. The first network element may determine, based on the first information, that the UP security protection policy is any one of the above policies.

It may be understood that the “required” may be used for instructing the PDU session to use the UP integrity protection, or it may be considered that the PDU session must use the UP integrity protection.

For example, if the UP security protection policy is “preferred”, the UP security protection policy may be used for instructing the PDU session to preferably use the UP integrity protection. That is, some special conditions may be preset; in a case where the special conditions are met, it may be determined that the PDU session does not use the UP integrity protection; and in a case where the special conditions are not met, it may be the default that the PDU session uses the UP integrity protection. Alternatively, some special conditions may be preset; in a case where the special conditions are met, it may be determined that the PDU session uses the UP integrity protection; and in a case where the special conditions are not met, it may be the default that the PDU session does not use the UP integrity protection.

For another example, if it is determined that the UP security protection policy is “not needed”, the UP security protection policy may be used for instructing the PDU session not to use the UP integrity protection. It may be understood that “not needed” may be used for instructing the PDU session to prohibit to use the UP integrity protection, or it may be considered that the PDU session must not use the UP integrity protection.

In some embodiments, the UP security protection policy may include UP integrity protection, which is referred to as UP integrity security protection, or referred to as a UP integrity protection policy. It may be understood that the UP integrity protection protects the integrity of the data, for example, protects the integrity of the satellite coverage information, to prevent the satellite coverage information from being maliciously tampered. Certainly, in some other embodiments, the UP security protection policy may further include UP confidentiality protection, which is referred to as UP confidentiality security protection, or referred to as a UP confidentiality protection policy. It can be understood that the UP confidentiality protection protects confidential information of the data. For example, data confidentiality transmitted in the PDU session is protected, to prevent confidential or private related information, etc., from being tampered.

It may be understood that each step shown in FIG. 9 may be implemented in any combination with or separately and independently from each step shown in FIG. 2, each step shown in FIG. 3, each step shown in FIG. 4, each step shown in FIG. 5, each step shown in FIG. 6, each step shown in FIG. 7, and each step shown in FIG. 8, which is not limited in the present disclosure.

In the present disclosure, the terminal sends the third information, so that the first network element and the second network element may instruct, based on the third information, the terminal to perform the PDU session by using UP security protection, and so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In the communication method provided by the embodiment of the present disclosure, FIG. 10 is a flowchart of still another communication method shown according to an exemplary embodiment. The method is performed by the terminal, and as shown in FIG. 10, the method may further include the following step S91.

At step S91, fifth information is received.

In some embodiments, the terminal may further receive the fifth information. The fifth information may instruct the terminal to use the UP integrity protection.

For example, the terminal may receive, through a Uu interface, the fifth information sent by the access network device. For example, the terminal receives, through the Uu interface, the fifth information sent by the NTN-RAN. The fifth information may be used for instructing the PDU session established between the terminal and the NTN-RAN to use the UP integrity protection. It may be understood that the Uu interface represents an interface for communication between the terminal and the access network device. The fifth information may carry information indicating that the UP security protection policy is to use the UP integrity protection. For example, the fifth information carries information indicating that the UP security protection policy is “required”.

For example, the terminal receives the fifth information to determine that the UP security protection policy is “required”. The terminal may perform message integrity verification code calculation on data communicated between the terminal and the access network device based on a preconfigured key, to ensure that the UP integrity protection is performed on data sent and/or received between the terminal and the access network device.

It may be understood that each step shown in FIG. 10 may be implemented in any combination with or separately and independently from each step shown in FIG. 2, each step shown in FIG. 3, each step shown in FIG. 4, each step shown in FIG. 5, each step shown in FIG. 6, each step shown in FIG. 7, each step shown in FIG. 8, and each step shown in FIG. 9, which is not limited in the present disclosure.

In the present disclosure, the terminal receives the fifth information sent by the access network device, and determines that the terminal performs the PDU session by using the UP security protection, so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

Based on the same concept, the present disclosure further provides a communication method performed by an access network device.

FIG. 11 is a flowchart of yet another communication method shown according to an exemplary embodiment. As shown in FIG. 11, the method is performed by an access network device and may include the following steps S101-S102.

At step S101, fourth information is received.

In some embodiments, the access network device may receive the fourth information sent by the first network element. The fourth information may instruct the access network device to use the UP integrity protection.

For example, the access network device may be an NTN-RAN, and the second network element is an AMF network element. The NTN-RAN may receive fourth information sent by the AMF network element, where the fourth information carries information indicating that the UP security protection policy is to use the UP integrity protection. The fourth information may be an “N2 PDU session request”. The “N2 PDU session request” carries information indicating that the UP security protection policy is “required”.

It may be understood that when the access network device receives the “N2 PDU session request” carrying information indicating that the UP security protection policy is “required”, the access network device may determine that the UP security protection policy of the PDU session established between the access network device and the terminal is “required”. The access network device may perform message integrity verification code calculation on data communicated between the access network device and the terminal based on a preconfigured key, to ensure that the UP integrity protection is performed on data sent and/or received between the access network device and the terminal.

At step S102, fifth information is sent.

In some embodiments, the access network device may send the fifth information. The fifth information may instruct the terminal to use the UP integrity protection.

For example, the access network device may send the fifth information to the terminal through the Uu interface. For example, the NTN-RAN sends the fifth information to the terminal through the Uu interface. The fifth information may be used for instructing the PDU session established between the NTN-RAN and the terminal to use the UP integrity protection. It may be understood that the Uu interface represents an interface for communication between the terminal and the access network device. The fifth information may carry information indicating that the UP security protection policy is to use the UP integrity protection. For example, the fifth information carries information indicating that the UP security protection policy is “required”.

In some embodiments, the UP security protection policy may include a first policy, a second policy, and a third policy. The first policy may be denoted as “required”. The second policy may be denoted as “preferred”. The third policy may be denoted as “not needed”. The first network element may determine, based on the first information, that the UP security protection policy is any one of the above policies.

It may be understood that the “required” may be used for instructing the PDU session to use the UP integrity protection, or it may be considered that the PDU session must use the UP integrity protection.

For example, if the UP security protection policy is “preferred”, the UP security protection policy may be used for instructing the PDU session to preferably use the UP integrity protection. That is, some special conditions may be preset; in a case where the special conditions are met, it may be determined that the PDU session does not use the UP integrity protection; and in a case where the special conditions are not met, it may be the default that the PDU session uses the UP integrity protection. Alternatively, some special conditions may be preset; in a case where the special conditions are met, it may be determined that the PDU session uses the UP integrity protection; and in a case where the special conditions are not met, it may be the default that the PDU session does not use the UP integrity protection.

For another example, if it is determined that the UP security protection policy is “not needed”, the UP security protection policy may be used for instructing the PDU session not to use the UP integrity protection. It may be understood that “not needed” may be used for instructing the PDU session to prohibit to use the UP integrity protection, or it may be considered that the PDU session must not use the UP integrity protection.

In some embodiments, the UP security protection policy may include UP integrity protection, which is referred to as UP integrity security protection, or referred to as a UP integrity protection policy. It may be understood that the UP integrity protection protects the integrity of the data, for example, protects the integrity of the satellite coverage information, to prevent the satellite coverage information from being maliciously tampered. Certainly, in some other embodiments, the UP security protection policy may further include UP confidentiality protection, which is referred to as UP confidentiality security protection, or referred to as a UP confidentiality protection policy. It can be understood that the UP confidentiality protection protects confidential information of the data. For example, data confidentiality transmitted in the PDU session is protected, to prevent confidential or private related information, etc., from being tampered.

It may be understood that each step shown in FIG. 11 may be implemented in any combination with or separately and independently from each step shown in FIG. 2, each step shown in FIG. 3, each step shown in FIG. 4, each step shown in FIG. 5, each step shown in FIG. 6, each step shown in FIG. 7, each step shown in FIG. 8, each step shown in FIG. 9, and each step shown in FIG. 10, which is not limited in the present disclosure.

In the present disclosure, the access network device sends the fifth information to instruct the terminal to perform the PDU session by using the UP security protection, so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

FIG. 12 is a flowchart of another communication method shown according to an exemplary embodiment. As shown in FIG. 12, the method is performed by a core network device and the core network device may include a first network element and a second network element. This method may include the following steps S111-S113.

At step S111, the second network element sends the first information to the first network element.

In some embodiments, the second network element may send the first information to the first network element. The first network element may receive the first information sent by the second network element. The first information is for instructing to perform a configuration for the terminal to establish a PDU session for obtaining the satellite coverage information. The PDU session may be a PDU session between a terminal and an access network device.

At step S112, the first network element determines the UP security protection policy based on the first information.

In some embodiments, the first network element determines the UP security protection policy based on the first information received from the second network element in the step S111. The UP security protection policy is used for instructing the PDU session to use the UP integrity protection.

At step S113, the first network element sends the second information to the second network element.

In some embodiments, the first network element sends the second information to the second network element. The second information is used for indicating the UP security protection policy.

In some embodiments, the second network element may receive the third information sent by the terminal. The third information may carry a DNN that may provide the satellite coverage information, or the third information carries first indication information, where the first indication information is for indicating to request the satellite coverage information.

It may be understood that a specific implementation process of each step shown in FIG. 12 may refer to the embodiments related to the first network element in FIG. 2 and FIG. 3, and refer to the embodiments related to the second network element in FIG. 4 to FIG. 8, which will not be repeated in the present disclosure.

In the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

FIG. 13 is a schematic diagram of an interaction of a communication method shown according to an exemplary embodiment.

As shown in FIG. 13, the present disclosure provides a schematic diagram of a signaling interaction of a communication method. It can be seen that the communication method may be applied to the communication system 100 shown in FIG. 1. The communication system 100 may include a terminal 110, an access network device 120, a first network element 1301, and a second network element 1302.

In some embodiments, UP connection security is activated based on a security policy sent by a core network, and the security policy may be set by a unified data management (UDM) network element or an SMF network element based on a specific service requested by the terminal. The SMF network element may determine the UP security protection policy when establishing the PDU session based on the following items.

For example, the SMF network element may determine the UP security protection policy based on the UP security protection policy in subscription information. The SMF network element may determine the UP security protection policy from the SM subscription information received by the UDM network element. For example, the SM subscription information carries information indicating the UP security protection policy.

For another example, in a case where the UDM network element does not provide the UP security protection policy, the SMF network element may preconfigure the UP security protection policy for each DNN.

The UP security protection policy may include a UP integrity protection policy and a UP confidentiality protection policy. The UP security protection policy may be configured as “required”, “preferred”, or “not needed”. These UP security protection policies may indicate whether the UP security protection policies should be activated at the Uu interface for all data radio bearers (DRBs) belonging to this PDU session. The UP security protection policies may be used to activate corresponding UP integrity protection and/or UP confidentiality protection for all DRBs belonging to the PDU session.

As shown in FIG. 13, the method may include the following steps S121-S126.

At step S121, the terminal 110 sends the third information to the second network element 1302.

For example, the terminal 110 sends a “PDU session establishment request” to the AMF network element. For example, the terminal sends the third information to the NTN-RAN, and forwards the third information to the AMF network element via the NTN-RAN. The “PDU session establishment request” carries the DNN including the satellite coverage information.

It may be understood that the “PDU session establishment request” sent by the terminal is used for indicating to establish a PDU session between the terminal and the access network device.

At step S122, the second network element 1302 determines, based on the DNN, the first network element 1301 corresponding to the DNN.

For example, the AMF network element determines the SMF network element corresponding to the DNN, based on the DNN carried in the third information.

At step S123, the second network element 1302 sends the first information to the first network element 1301.

For example, the AMF network element sends the “Nsmf_PDUSession_CreateSMContext request” to the SMF network element determined in the step S122. The “Nsmf_PDUSession_CreateSMContext request” carries the DNN.

At step S124, the first network element 1301 sends the second information to the second network element 1302.

For example, the SMF network element determines, based on the DNN carried in the “Nsmf_PDUSession_CreateSMContext request”, that the UP security protection policy is “required”. The SMF network element sends the “Nsmf_PDUSession_CreateSMContext response” to the AMF network element, where the “Nsmf_PDUSession_CreateSMContext response” indicates that the UP security protection policy is set as “required”.

For example, if the UP security protection policy is configured in the SM subscription information provided by the UDM network element, and the UP security protection policy corresponding to the DNN is not preconfigured in the SMF network element, the SMF network element may determine, based on the UP security protection policy configured in the SM subscription information, that the UP security protection policy is set as “required”. For another example, if the UP security protection policy corresponding to the DNN is preconfigured in the SMF network element, regardless of whether the UP security protection policy is configured in the SM subscription information, the SMF network element may determine, based on the locally configured UP security protection policy corresponding to the DNN, that the UP security protection policy is set as “required”.

Certainly, the SMF network element may locally configure the UP security protection policy corresponding to each DNN as “required”, for example.

At step S125, the second network element 1302 sends the fourth information to the access network device 120.

For example, when receiving “Nsmf_PDUSession_CreateSMContext response” sent by the SMF network element indicating that the UP security protection policy is set as “required”, the AMF network element may send the “N2 PDU session request” to the NTN-RAN. The “N2 PDU session request” carries information indicating that the UP security protection policy is “required”.

At step S126, the access network device 120 sends fifth information to the terminal 110.

For example, after receiving the “N2 PDU session request” that is sent by the AMF network element and carries the information indicating that the UP security protection policy is “required”, the NTN-RAN may send the fifth information to the terminal 110 through the Uu interface, and notify the terminal 110 that the UP security protection policy is “required” through the fifth information.

It may be understood that in the above embodiments, an external server able to provide the satellite coverage information may be deployed in the DNN.

In the method shown in FIG. 11, according to the UP security protection policy provided by the SMF network element, because it is indicated that the integrity protection policy is “required”, the NTN-RAN may activate UP integrity protection of each DRB by using RRC signaling. The NTN-RAN may determine that UP integrity protection on the terminal side is activated through the Uu interface. For example, the NTN-RAN includes an activation indication of the UP integrity protection in the RRC connection reconfiguration request. Then, the terminal performs the UP integrity protection policy same as the NTN-RAN based on the activation indication sent by the NTN-RAN.

It may be understood that the specific implementation of each step in FIG. 11 may refer to descriptions of corresponding embodiments in FIG. 2 to FIG. 10, which will not be repeated in the present disclosure.

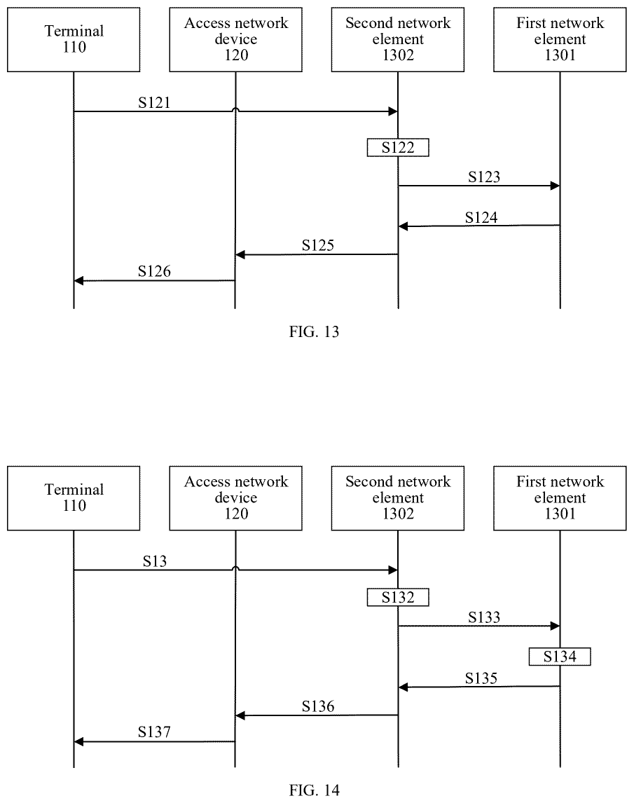

FIG. 14 is a schematic diagram of an interaction of another communication method shown according to an exemplary embodiment.

As shown in FIG. 14, the present disclosure provides a schematic diagram of a signaling interaction of another communication method. It can be seen that the communication method may be applied to the communication system 100 shown in FIG. 1. The communication system 100 may include a terminal 110, an access network device 120, a first network element 1301, and a second network element 1302.

A difference between FIG. 14 and FIG. 13 lies in that a DNN is not configured in the third information sent by the terminal, and in this case, the method may include the following steps S131-S137

At step S131, the terminal 110 sends the third information to the second network element 1302.

For example, the terminal 110 sends a “PDU session establishment request” to the AMF network element. For example, the terminal sends the third information to the NTN-RAN, and forwards the third information to the AMF network element via the NTN-RAN. The “PDU session establishment request” does not carry the DNN including the satellite coverage information, but carries first indication information. The first indication information may represent “indication for coverage information”.

It may be understood that the “PDU session establishment request” sent by the terminal is used for indicating to establish a PDU session between the terminal and the access network device.

At step S132, the second network element 1302 may determine, based on the first indication information, a first network element 1301 that supports selecting the resource of the satellite coverage information for the terminal.

For example, the AMF network element determines, based on the “indication for coverage information”, the SMF network element that supports selecting the resource of the satellite coverage information for the terminal.

At step S133, the second network element 1302 sends the first information to the first network element 1301.

For example, the AMF network element sends the “Nsmf_PDUSession_CreateSMContext request” to the SMF network element determined in the step S132. The “Nsmf_PDUSession_CreateSMContext request” carries the “indication for coverage information”.

At step S134, the first network element 1301 determines, based on the first indication information in the first information, the DNN providing the satellite coverage information.

For example, the SMF network element determines, based on the “indication for coverage information” carried in the “Nsmf_PDUSession_CreateSMContext request”, the DNN that may provide the satellite coverage information for the terminal 110. The SMF network element determines, based on the determined DNN, that the UP security protection policy corresponding to the DNN is set as “required”.

At step S135, the first network element 1301 sends the second information to the second network element 1302.

For example, the SMF network element sends the “Nsmf_PDUSession_CreateSMContext response” to the AMF network element, where the “Nsmf_PDUSession_CreateSMContext response” indicates that the UP security protection policy is set as “required”.

At step S136, the second network element 1302 sends the fourth information to the access network device 120.

For example, when receiving “Nsmf_PDUSession_CreateSMContext response” sent by the SMF network element indicating that the UP security protection policy is set as “required”, the AMF network element may send the “N2 PDU session request” to the NTN-RAN. The “N2 PDU session request” carries information indicating that the UP security protection policy is “required”.

At step S137, the access network device 120 sends fifth information to the terminal 110.

For example, after receiving the “N2 PDU session request” that is sent by the AMF network element and carries the information indicating that the UP security protection policy is “required”, the NTN-RAN may send the fifth information to the terminal 110 through the Uu interface, and notify the terminal 110 that the UP security protection policy is “required” through the fifth information.

It may be understood that in the above embodiments, the DNN that may provide the satellite coverage information may not be configured in the third information sent by the terminal. In this case, the third information may carry an indication for requesting the satellite coverage information, so that the AMF network element selects an SMF network element that supports providing the satellite coverage information, and so that the corresponding SMF network element determines that the UP security protection policy is “required”.

It should be noted that those skilled in the art may understand that various implementations/embodiments involved in the embodiments of the present disclosure may be used in combination with the foregoing embodiments, or may be used independently. Whether used alone or in combination with the foregoing embodiments, the implementation principle is similar. In the embodiments of the present disclosure, a part of the embodiments are described in implementations used together. Of course, those skilled in the art may understand that such an example is not a limitation on the embodiments of the present disclosure.

Based on the same concept, embodiments of the present disclosure further provide communication apparatuses and devices.

It can be understood that the communication apparatuses and the devices provided by the embodiments of the present disclosure, to achieve the above functions, include corresponding hardware structures and/or software modules to perform various functions. Combined with units and algorithm steps of various examples disclosed in the embodiments of the present disclosure, the embodiments of the present disclosure can be implemented in hardware or a combination of the hardware and computer software. Whether a certain function is performed in the hardware or the computer software driving the hardware depends on specific applications and design constraint conditions of technical solutions. Those skilled in the art may use different methods to implement the described functions for each specific application, but such implementation should not be considered to be beyond the scope of the technical solutions of the embodiments of the present disclosure.

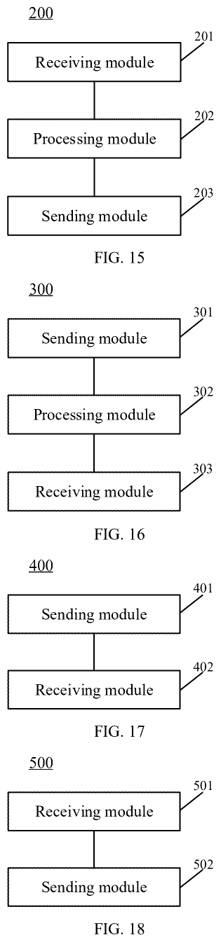

FIG. 15 is a schematic diagram of a communication apparatus shown according to an exemplary embodiment. Referring to FIG. 15, the apparatus 200 includes: a receiving module 201, configured to receive first information, where the first information is for instructing to perform a configuration for a terminal to establish a PDU session for obtaining satellite coverage information; a processing module 202, configured to determine a UP security protection policy based on the first information, where the UP security protection policy is for instructing the PDU session to use UP integrity protection; and a sending module 203, configured to send second information, where the second information indicates the UP security protection policy.

In the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some implementations, the first information carries a DNN that may provide the satellite coverage information; and the processing module 202 is further configured to determine, based on a correspondence relationship between DNNs and UP security protection policies, that the UP security protection policy corresponding to the DNN is to use the UP integrity protection.

In the present disclosure, in the case where the first information carries the DNN, by instructing the terminal to perform the PDU session by using the UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some implementations, the first information carries first indication information, where the first indication information is used for indicating to request the satellite coverage information; and the processing module 202 is further configured to: determine a DNN providing the satellite coverage information; and determine, based on a correspondence relationship between DNNs and UP security protection policies, that the UP security protection policy corresponding to the DNN is to use the UP integrity protection.

In the present disclosure, the first information does not carry the DNN, and the first information carries the first indication information used for indicating to request the satellite coverage information. In this case, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

It may be understood that the apparatus 200 may perform any one method related to the first network element. A specific implementation process may refer to the embodiments corresponding to the first network element, which will not be repeated in the present disclosure.

FIG. 16 is a schematic diagram of another communication apparatus shown according to an exemplary embodiment. Referring to FIG. 16, the apparatus 300 includes: a sending module 301, configured to send first information, where the first information is for instructing to perform a configuration for a terminal to establish a PDU session for obtaining satellite coverage information; and a receiving module 302, configured to receive second information, where the second information indicates a UP security protection policy, and the UP security protection policy is for instructing the PDU session to use UP integrity protection.

In the present disclosure, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some implementations, the first information carries first indication information, where the first indication information is for indicating to request the satellite coverage information; the apparatus 300 further includes: a processing module 303, configured to determine, based on the first indication information, a first network element that supports selecting a resource of the satellite coverage information for the terminal; and the sending module 301 is further configured to send the first information to the first network element, where the first information carries the first indication information.

In the present disclosure, the first information does not carry the DNN, and the first information carries the first indication information used for indicating to request the satellite coverage information. In this case, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some implementations, the receiving module 302 is further configured to receive third information, where the third information is for indicating to request to establish the PDU session, and the third information carries the first indication information.

In the present disclosure, the second network element receives the third information carrying the first indication information, to send the first information carrying the first indication information to the first network element. In this way, by instructing the terminal to perform the PDU session by using UP security protection, the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some implementations, the first information carries a DNN that may provide the satellite coverage information; the processing module 303 is further configured to determine, based on the DNN, a first network element corresponding to the DNN; and the sending module 301 is further configured to send the first information to the first network element, where the first information carries the DNN.

In some implementations, the receiving module 302 is further configured to receive third information, where the third information is for indicating to request to establish the PDU session, and the third information carries the DNN.

It may be understood that the apparatus 300 may perform any one method related to the second network element. A specific implementation process may refer to the embodiments corresponding to the second network element, which will not be repeated in the present disclosure.

FIG. 17 is a schematic diagram of still another communication apparatus shown according to an exemplary embodiment. Referring to FIG. 17, the apparatus 400 includes a sending module 401, configured to send third information, where the third information is for indicating to request to establish a PDU session for obtaining satellite coverage information; where the third information includes first indication information, and the first indication information is for indicating to request the satellite coverage information.

In the present disclosure, the terminal sends the third information, so that the first network element and the second network element may instruct, based on the third information, the terminal to perform the PDU session by using UP security protection, and so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

In some embodiments, the apparatus 400 further includes a receiving module 402, configured to receive fifth information.

It may be understood that the apparatus 400 may perform any one method related to the terminal. A specific implementation process may refer to the embodiments corresponding to the terminal, which will not be repeated in the present disclosure.

In the present disclosure, the terminal receives the fifth information sent by the access network device, and determines that the terminal performs the PDU session by using the UP security protection, so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

FIG. 18 is a schematic diagram of still another communication apparatus shown according to an exemplary embodiment. Referring to FIG. 18, the apparatus 500 includes a receiving module 501, configured to receive fourth information. The sending module 502 is configured to send the fifth information.

In the present disclosure, the access network device sends the fifth information to instruct the terminal to perform the PDU session by using the UP security protection, so that the satellite coverage information in the DNN corresponding to the PDU session is safely protected without being tampered, which improves the accuracy of determining, by the terminal, the time period corresponding to the satellite coverage range, and prevents the terminal from being attacked by the DoS.

It may be understood that the apparatus 500 may perform any one method related to the access network device. A specific implementation process may refer to the embodiments corresponding to the access network device, which will not be repeated in the present disclosure.

It may be understood that the apparatus 400 and the apparatus 500 may further include a processing module. It should be understood that the apparatus 200, the apparatus 300, the apparatus 400, and the apparatus 500 are not limited to various modules shown in the figures, and may further include corresponding other modules according to an actual situation, which is not limited in the present disclosure.

The specific manners in which each of the modules of the apparatus in the above embodiments performs operations have been described in detail in the embodiments related to the methods, and will not be explained here in detail.

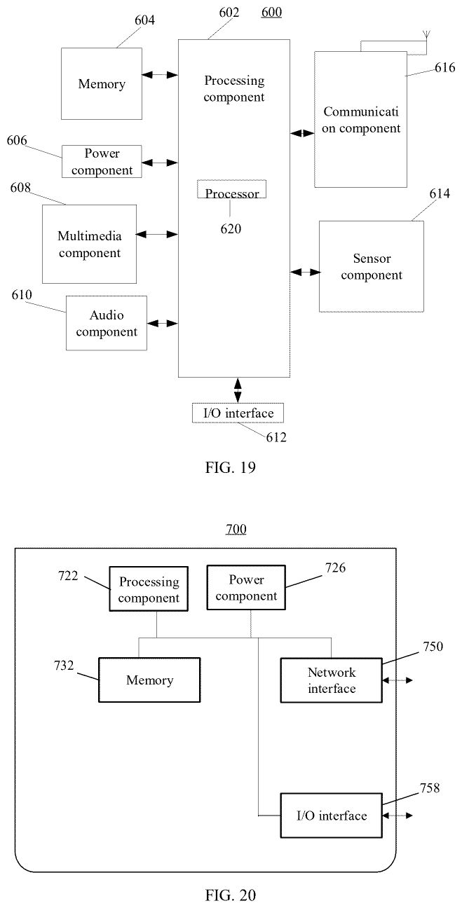

FIG. 19 is a schematic diagram of a communication apparatus shown according to an exemplary embodiment. For example, the device 600 may be any one terminal, such as a mobile phone, a computer, a digital broadcast terminal, a message transceiving device, a game console, a tablet device, a medical device, a fitness device, a personal digital assistant, etc. For example, the device 600 is the terminal 110 mentioned above.

Referring to FIG. 19, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls the overall operation of the device 600, such as operations associated with display, phone calls, data communication, camera operations, and recording operations. The processing component 602 may include one or more processors 620 to execute instructions to complete all or part of the steps in the above methods. Additionally, the processing component 602 may include one or more modules to facilitate interaction between the processing component 602 and other components. For example, the processing component 602 may include a multimedia module to facilitate interaction between the multimedia component 608 and the processing component 602.

The memory 604 is configured to store various types of data to support operations of the device 600. Examples of such data include instructions, contact data, phonebook data, messages, pictures, videos, etc., for any application program or method operating on the device 600. The memory 604 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 606 provides power to various components of the device 600. The power component 606 may include a power supply management system, one or more power supplies, and other components that are associated with generating, managing, and distributing power for the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 608 includes a front-facing camera and/or a rear-facing camera. When the device 600 is in an operation mode, such as a shooting mode or a video mode, the front-facing camera and/or the rear-facing camera may receive external multimedia data. Each of the front-facing camera and rear-facing camera may be a fixed optical lens system or have a focal length and an optical zoom capability.

The audio component 610 is configured to output and/or input audio signals. For example, the audio component 610 includes a microphone (MIC). The microphone is configured to receive external audio signals when the device 600 is in the operating mode, such as a call mode, a recording mode, and a speech recognition mode. The received audio signals may be further stored in the memory 604 or sent via the communication component 616. In some embodiments, the audio component 610 also includes a speaker for outputting the audio signals.

The I/O interface 612 provides an interface between the processing component 602 and peripheral interface modules. The peripheral interface modules may be keyboards, click wheels, buttons, etc. These buttons may include but are not limited to: a home button, a volume button, a start button, and a lock button.

The sensor component 614 includes one or more sensors to provide various aspects of state assessment for the device 600. For example, the sensor component 614 may detect an open/closed state of the device 600, relative positioning of components that are for example, a display and keypad of the device 600. The sensor component 614 may also detect a position change of the device 600 or of a component of the device 600, the presence or absence of the user contacting with the device 600, an orientation or acceleration/deceleration of the device 600, and a temperature change of the device 600. The sensor component 614 may include a proximity sensor configured to detect the presence of nearby objects without any physical contact. The sensor component 614 may also include a light sensor, such as a CMOS or CCD image sensor, for use in an imaging application. In some embodiments, the sensor component 614 may also include an acceleration sensor, a gyroscope sensor, a magnetic sensor, a pressure sensor, or a temperature sensor.

The communication component 616 is configured to facilitate wired or wireless communication between the device 600 and other devices. The device 600 may access a wireless network based on a communication standard, such as WiFi, 2G, 3G, or a combination of them. In an exemplary embodiment, the communication component 616 receives, via a broadcast channel, a broadcast signal or broadcast-related information from an external broadcast management system. In an exemplary embodiment, the communication component 616 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the device 600 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an exemplary embodiment, a non-transitory computer-readable storage medium including instructions is also provided, such as the memory 604 including the instructions. The above instructions may be executed by the processor 620 of the device 600 to complete the above methods. For example, the non-transitory computer-readable storage medium may be a ROM, a random access memory (RAM), a CD-ROM, a magnetic tape, a floppy disk, an optical data storage device, etc.

FIG. 20 is a schematic diagram of another communication apparatus shown according to an exemplary embodiment. For example, the device 700 may be provided as a base station or a server. The device 700 may be the access network device 120 or the core network device 130 mentioned above. For example, the device 700 is the first network element 1301, or the device 700 may be the second network element 1302. Referring to FIG. 20, the device 700 includes a processing component 722, that further includes one or more processors, and memory resources represented by a memory 732, for storing instructions that is executable by the processing component 722, such as an application program. The application program stored in the memory 732 may include one or more modules that each corresponds to a set of instructions. In addition, the processing component 722 is configured for executing the instructions to perform the above methods.

The device 700 may also include a power component 726 configured to perform power management of the device 700, a wired or wireless network interface 750 configured to connect the device 700 to the network, and an input/output (I/O) interface 758. The device 700 may operate an operating system stored in the memory 732, such as Windows Server™, Mac OS X™, Unix™, Linux™, FreeBSD™, or a similar operating system.

Therefore, in the present disclosure, by instructing the terminal to perform the PDU session by using UP security protection, the satellite coverage information in the DNN corresponding to the PDU session is safely protected without being tampered during the transmission and/or reception of the satellite coverage information from the external server to the terminal, which improves the accuracy of determining, by the terminal, the time period corresponding to the satellite coverage range, and prevents the terminal from being attacked by the DOS.

According to a first aspect of the embodiments of the present disclosure, a communication method is provided. The method is performed by a first network element and includes: receiving first information, where the first information is for instructing to perform a configuration for a terminal to establish a packet data unit (PDU) session for obtaining satellite coverage information; determining a user plane (UP) security protection policy based on the first information, where the UP security protection policy is for instructing the PDU session to use UP integrity protection; and sending second information, where the second information indicates the UP security protection policy.

In some implementations, the first information carries a data network name (DNN) that may provide the satellite coverage information; the determining the UP security protection policy based on the first information, includes: determining, based on a correspondence relationship between DNNs and UP security protection policies, that the UP security protection policy corresponding to the DNN is to use the UP integrity protection.

In some implementations, the first information carries first indication information, and the first indication information is for indicating to request the satellite coverage information; the determining the UP security protection policy based on the first information, includes: determining, based on the first indication information, a DNN providing the satellite coverage information; and determining, based on a correspondence relationship between DNNs and UP security protection policies, that the UP security protection policy corresponding to the DNN is to use the UP integrity protection.

According to a second aspect of the embodiments of the present disclosure, a communication method is provided. The method is performed by a second network element and includes: sending first information, where the first information is for instructing to perform a configuration for a terminal to establish a packet data unit (PDU) session for obtaining satellite coverage information; and receiving second information, where the second information indicates a UP security protection policy, and the UP security protection policy is for instructing the PDU session to use UP integrity protection.

In some implementations, the first information carries first indication information, where the first indication information is for indicating to request the satellite coverage information; the method further includes: determining, based on the first indication information, a first network element that supports selecting a resource of the satellite coverage information for the terminal; and the sending first information includes: sending the first information to the first network element, where the first information carries the first indication information.

In some implementations, the method further includes: receiving third information, where the third information is for indicating to request to establish the PDU session, and the third information carries the first indication information.

In some implementations, the first information carries a data network name (DNN) that may provide the satellite coverage information; the method further includes: determining, based on the DNN, a first network element corresponding to the DNN; and the sending first information, includes: sending the first information to the first network element, where the first information carries the DNN.

In some implementations, the method further includes: receiving third information, where the third information is for indicating to request to establish the PDU session, and the third information carries the DNN.

According to a third aspect of the embodiments of the present disclosure, a communication method is provided. The communication method is performed by a terminal and includes: sending third information, where the third information is for indicating to request to establish a packet data unit (PDU) session for obtaining satellite coverage information; where the third information includes first indication information, and the first indication information is for indicating to request the satellite coverage information.

According to a fourth aspect of the embodiments of the present disclosure, a communication method is provided. The method is performed by performed by a core network device, where the core network device includes a first network element and a second network element, and the method includes: sending, by the second network element, first information to the first network element, where the first information is for instructing to perform a configuration for a terminal to establish a packet data unit (PDU) session for obtaining satellite coverage information, and the PDU session is a PDU session between the terminal and an access network device; determining, by the first network element, a user plane (UP) security protection policy based on the first information, where the UP security protection policy is for instructing the PDU session to use UP integrity protection; and sending, by the first network element, second information to the second network element, where the second information indicates the UP security protection policy.

In some implementations, the method further includes: receiving, by the second network element, third information sent by the terminal, where the third information is for indicating to request to establish the PDU session, and the third information carries a DNN that may provide the satellite coverage information, or the third information carries first indication information, where the first indication information is for indicating to request the satellite coverage information.

According to a fifth aspect of the embodiments of the present disclosure, a first communication apparatus is provided. The first communication apparatus is configured in a first network element and includes: a receiving module, configured to receive first information, where the first information is for instructing to perform a configuration for a terminal to establish a packet data unit (PDU) session for obtaining satellite coverage information; a processing module, configured to determine a user plane (UP) security protection policy based on the first information, where the UP security protection policy is for instructing the PDU session to use UP integrity protection; and a sending module, configured to send second information, where the second information indicates the UP security protection policy.

In some implementations, the first information carries a DNN that may provide the satellite coverage information; and the processing module is further configured to determine, based on a correspondence relationship between DNNs and UP security protection policies, that the UP security protection policy corresponding to the DNN is to use the UP integrity protection.

In some implementations, the first information carries first indication information, where the first indication information is used for indicating to request the satellite coverage information; and the processing module is further configured to: determine a DNN providing the satellite coverage information; and determine, based on a correspondence relationship between DNNs and UP security protection policies, that the UP security protection policy corresponding to the DNN is to use the UP integrity protection.

According to a sixth aspect of the embodiments of the present disclosure, a second communication apparatus is provided. The second communication apparatus is configured in a second network element and includes: a sending module, configured to send first information, where the first information is for instructing to perform a configuration for a terminal to establish a packet data unit (PDU) session for obtaining satellite coverage information; and a receiving module, configured to receive second information, where the second information indicates a UP security protection policy, and the UP security protection policy is for instructing the PDU session to use UP integrity protection.

In some implementations, the first information carries first indication information, where the first indication information is for indicating to request the satellite coverage information; the apparatus further includes: a processing module, configured to determine, based on the first indication information, a first network element that supports selecting a resource of the satellite coverage information for the terminal; and the sending module is further configured to send the first information to the first network element, where the first information carries the first indication information.

In some implementations, the receiving module is further configured to receive third information, where the third information is for indicating to request to establish the PDU session, and the third information carries the first indication information.

In some implementations, the first information carries a DNN that may provide the satellite coverage information; the processing module is further configured to determine, based on the DNN, a first network element corresponding to the DNN; and the sending module is further configured to send the first information to the first network element, where the first information carries the DNN.

In some implementations, the receiving module is further configured to receive third information, where the third information is for indicating to request to establish the PDU session, and the third information carries the DNN.

According to a seventh aspect of the embodiments of the present disclosure, a third communication apparatus is provided. The third communication apparatus is configured in a terminal and includes: a sending module, configured to send third information, where the third information is for indicating to request to establish a packet data unit (PDU) session for obtaining satellite coverage information; where the third information includes first indication information, and the first indication information is for indicating to request the satellite coverage information.

According to an eighth aspect of the embodiments of the present disclosure, a communication device is provided. The communication device includes one or more processors and a memory configured to store instructions executable by the one or more processors; where the one or more processors are configured to perform the first aspect and any one method in the first aspect.

According to a ninth aspect of the embodiments of the present disclosure, a communication device is provided. The communication device includes one or more processors and a memory configured to store instructions executable by the one or more processors; where the one or more processors are configured to perform the second aspect and any one method in the second aspect.

According to a tenth aspect of the embodiments of the present disclosure, a communication device is provided. The communication device includes one or more processors and a memory configured to store instructions executable by the one or more processors; where the one or more processors are configured to perform the third aspect and any one method in the third aspect.

According to an eleventh aspect of the embodiments of the present disclosure, a non-transitory computer-readable storage medium is provided. Instructions in the storage medium, when executed by one or more processors of a first network element, enable the first network element to perform the first aspect and any one method in the first aspect.

According to a twelfth aspect of the embodiments of the present disclosure, a non-transitory computer-readable storage medium is provided. Instructions in the storage medium, when executed by one or more processors of a second network element, enable the second network element to perform the second aspect and any one method in the second aspect.

According to a thirteenth aspect of the embodiments of the present disclosure, a non-transitory computer-readable storage medium is provided. Instructions in the storage medium, when executed by one or more processors of a terminal, enable the terminal to perform the third aspect and any one method in the third aspect.

Further, it can be understood that in the present disclosure, “multiple” refers to two or more; other quantifiers are similar thereto. “And/or” describes an association relationship of association objects, and represents that there may be three types of relationships. For example, A and/or B may represent: existence of A alone, existence of both A and B, and existence of B alone. The character “/” generally represents that a relationship between the context association objects is an “or” relationship. The singular forms of “a/an,” “said,” and “the” are also intended to include the plural form, unless the context clearly indicates other meanings.

It can be further understood that the terms “first,” “second,” etc., are used to describe various information, but such information should not be limited to these terms. These terms are only used to distinguish the same type of information from each other and do not indicate a specific order or importance. In fact, expressions such as “first” and “second” may be used interchangeably. For example, without departing from the scope of the present disclosure, first information may also be referred to as second information, and similarly, the second information may also be referred to as the first information.

Further, it can be understood that the meaning of the terms, such as “in response to,” or “if” in the present disclosure depend on the context and the actual use scenario, as used herein, the term “in response to” may be interpreted as “when,” “while,” “if,” or “in a case”.

It can be further understood that in the embodiments of the present embodiment, although the operations are described in a specific order in the accompanying drawings, it should not be understood as requiring performance of these operations in a specific order or serial order as shown, or requiring performance of all shown operations to obtain the desired result. In specific environments, multitasking and parallel processing may be advantageous.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure.

It should be understood that the present disclosure is not limited to the precise structure described above and shown in the accompanying drawings, and various modifications and changes may be made without departing from its scope. The scope of the present disclosure is limited only by the scope of the appended claims.

1. A communication method, performed by a first network element and comprising:
receiving first information, wherein the first information is for instructing to perform a configuration for a terminal to establish a packet data unit (PDU) session for obtaining satellite coverage information;
determining a user plane (UP) security protection policy based on the first information, wherein the UP security protection policy is for instructing the PDU session to use UP integrity protection; and
sending second information, wherein the second information indicates the UP security protection policy.

2. The method of claim 1, wherein the first information carries a data network name (DNN) of a data network that is able to provide the satellite coverage information;
the determining the UP security protection policy based on the first information, comprises:
determining, based on a correspondence relationship between DNNs and UP security protection policies, that the UP security protection policy corresponding to the DNN is to use the UP integrity protection.

3. The method of claim 1, wherein the first information carries first indication information, wherein the first indication information is for indicating to request the satellite coverage information;
the determining the UP security protection policy based on the first information, comprises:
determining, based on the first indication information, a DNN of a data network providing the satellite coverage information; and
determining, based on a correspondence relationship between DNNs and UP security protection policies, that the UP security protection policy corresponding to the DNN is to use the UP integrity protection.

4. A communication method, performed by a second network element and comprising:
sending first information, wherein the first information is for instructing to perform a configuration for a terminal to establish a packet data unit (PDU) session for obtaining satellite coverage information; and
receiving second information, wherein the second information indicates a user plane (UP) security protection policy, wherein the UP security protection policy is for instructing the PDU session to use UP integrity protection.

5. The method of claim 4, wherein the first information carries first indication information, wherein the first indication information is for indicating to request the satellite coverage information;
the sending first information, comprises:
determining, based on the first indication information, a first network element that supports selecting a resource of the satellite coverage information for the terminal; and
sending the first information to the first network element, wherein the first information carries the first indication information.

6. The method of claim 5, further comprising:
receiving third information, wherein the third information is for indicating to request to establish the PDU session, and the third information carries the first indication information.

7. The method of claim 4, wherein the first information carries a data network name (DNN) of a data network that is able to provide the satellite coverage information;
the sending first information, comprises:
determining a first network element corresponding to the DNN; and
sending the first information to the first network element.

8. The method of claim 7, further comprising:
receiving third information, wherein the third information is for indicating to request to establish the PDU session, and the third information carries the DNN.

9. (canceled)

10. A communication method, performed by a core network device, wherein the core network device comprises a first network element and a second network element, and the method comprises:
sending, by the second network element, first information to the first network element, wherein the first information is for instructing to perform a configuration for a terminal to establish a packet data unit (PDU) session for obtaining satellite coverage information, wherein the PDU session is a PDU session between the terminal and an access network device;
determining, by the first network element, a user plane (UP) security protection policy based on the first information, wherein the UP security protection policy is for instructing the PDU session to use UP integrity protection; and
sending, by the first network element, second information to the second network element, wherein the second information indicates the UP security protection policy.

11. The method of claim 10, further comprising:
receiving, by the second network element, third information sent by the terminal, wherein the third information is for indicating to request to establish the PDU session, and the third information carries a data network name (DNN) of a data network that is able to provide the satellite coverage information, or the third information carries first indication information, wherein the first indication information is for indicating to request the satellite coverage information.

12.-14. (canceled)

15. A communication device, comprising:
one or more processors; and
a memory configured to store instructions executable by the one or more processors;
wherein the one or more processors are configured to perform the method of claim 1.

16. A communication device, comprising:
one or more processors; and
a memory configured to store instructions executable by the one or more processors;
wherein the one or more processors are configured to perform the method of claim 4.

17. A communication device, comprising:
one or more processors; and
a memory configured to store instructions executable by the one or more processors;
wherein the one or more processors are configured to perform the method of claim 10.

18. A non-transitory computer-readable storage medium, wherein instructions in the storage medium, when executed by one or more processors of a first network element, enable the first network element to perform the method of claim 1.

19. A non-transitory computer-readable storage medium, wherein instructions in the storage medium, when executed by one or more processors of a second network element, enable the second network element to perform the method of claim 4.

20. A non-transitory computer-readable storage medium, wherein instructions in the storage medium, when executed by one or more processors of a terminal, enable the terminal to perform the method of claim 10.
